(19) United States
(12) Patent Application Publication
(10) Pub. No.: US 2011/0232601 A1
(43) Pub. Date: Sep. 29, 2011

(54) COMPRESSION IGNITION ENGINE WITH BLENDED FUEL INJECTION

(75) Inventor: Hoisan Kim, Dunlap, IL (US)

(73) Assignee: CATERPILLAR INC., Peoria, IL (US)

(21) Appl. No.: 12/731,245

(22) Filed: Mar. 25, 2010

(51) Int. Cl. F02B 17/00; F02M 51/00

(52) U.S. Cl. 123/295; 123/478

(57) ABSTRACT

An engine includes an electronically controlled mixing ratio control valve with a first inlet fluidly connected to a source of gasoline, and a second inlet fluidly connected to a source of compression ignition fuel, such as distillate diesel fuel. An outlet from the mixing ratio control valve is fluidly connected to a fuel inlet of at least one fuel injector. The mixing ratio control valve varies a mixture ratio of gasoline to compression ignition fuel responsive to a control signal communicated from an electronic controller. The blended fuel may be pressurized to injection levels in the fuel injector, and injected directly into the engine cylinder. The compression ignition fuel is compression ignited, which in turn ignites the gasoline to produce a lower and better combination of undesirable emissions as a result of the combustion process.

### TECHNICAL FIELD

The present disclosure relates generally to compression ignition engines, and more particularly to injection and combustion of electronically controlled mixture ratios of gasoline and a compression ignition fuel.

### BACKGROUND

Engineers are constantly seeking new ways to reduce undesirable emissions from compression ignition engines. While undesirable constituents in exhaust emissions can be treated with ever more sophisticated aftertreatment systems, burning the fuel in a way that reduces the production of undesirable emissions in the first place has always been a desired alternative. Some of the undesirable emissions currently of concern include NOx, unburned hydrocarbons, and particulate matter. NOx is generally associated with higher combustion temperatures. Unburned hydrocarbons can sometimes be associated with fuel in remote portions of an engine cylinder not burning completely. Particulate matter production can be attributed to a variety of sources known in the art, including fuel composition and other factors. An overall reduction in undesirable emissions from the combustion space can be elusive, as reducing one of the undesirable emissions can often result in a substantial increase in another.

Although compression ignition engines are generally associated with diesel fuel, it is known to burn other less reactive fuels utilizing compression ignited diesel fuel to in turn ignite a less reactive fuel, such as natural gas or gasoline. In one specific engine example that was not motivated by emissions, U.S. Pat. No. 3,308,794 teaches a compression ignition engine that combines a small amount of diesel fuel with a predominantly larger volume of gasoline that is injected directly into the engine as a blend. The gasoline is ignited by the burning diesel fuel, which is compression ignited. Although this reference introduces the concept of igniting gasoline with a small amount of compression ignited diesel, it fails to consider emissions issues, nor does it contemplate or recognize that emissions may be reduced with an ability to vary the mixture ratio of gasoline to diesel independent of engine operating conditions.

The present disclosure is directed toward one or more of the problems set forth above.

### SUMMARY OF THE INVENTION

In one aspect, a fuel system includes a plurality of fuel injectors, a source of gasoline and a source of compression ignition fuel. An electronically controlled mixing ratio control valve has a first inlet fluidly connected to the source of gasoline, and a second inlet fluidly connected to the source of compression ignition fuel. An outlet of the mixing ratio control valve is fluidly connected to a fuel inlet of at least one of the fuel injectors. The mixing ratio control valve is movable among a plurality of configurations corresponding to different ratios of gasoline to compression ignition fuel in the outlet. An electronic controller is in control communication with the mixing ratio control valve.

In another aspect, a method of operating an engine includes compressing air in an engine cylinder beyond and autoignition condition of a compression ignition fuel. A first mixture of gasoline and compression ignition fuel of a first mixture ratio is injected into the engine cylinder. A change to a second mixture ratio is made responsive to a mixture ratio control signal communicated from an electronic controller to the mixing ratio control valve. The second mixture of gasoline and compression ignition fuel of the second mixture ratio is injected into the engine cylinder.

### BRIEF DESCRIPTION OF THE DRAWINGS

FIG. 1 is a schematic view of an engine and fuel system according to one aspect of the present disclosure;

FIG. 2 is a side sectioned diagrammatic view of a fuel injector from the fuel system of FIG. 1; and

FIG. 3 is a front sectioned diagrammatic view of a mixing ratio control valve from the fuel system of FIG. 1.

### DETAILED DESCRIPTION

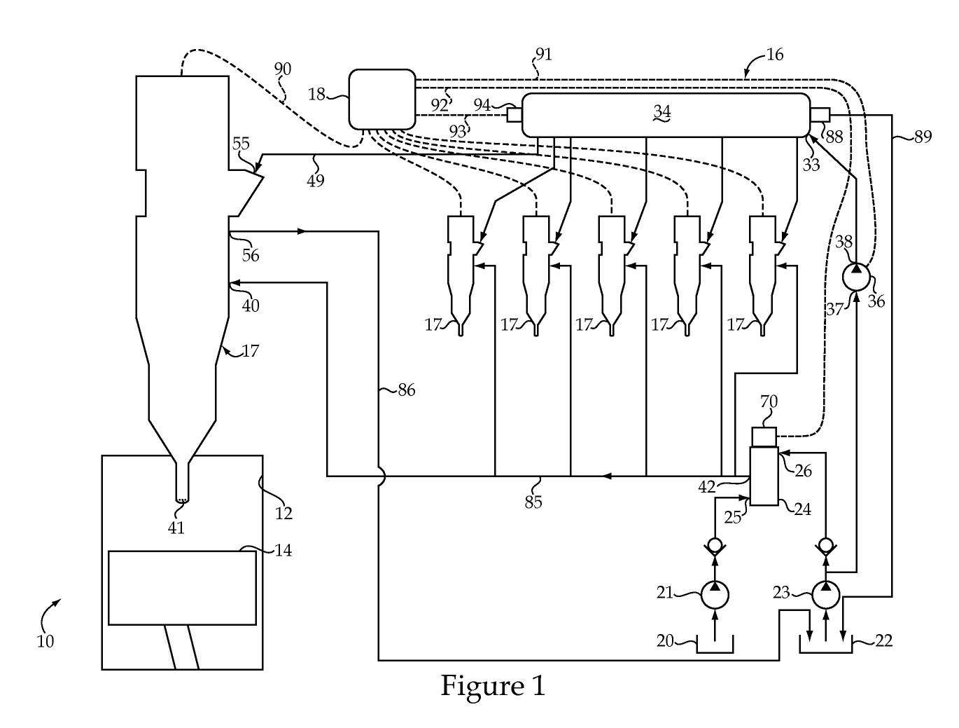

Referring to FIG. 1, an engine 10 includes a fuel system 16 with a plurality of fuel injectors 17. Engine 10 is shown as including six fuel injectors corresponding to a six cylinder engine, but those skilled in the art will appreciate that the teachings of the present disclosure are equally applicable to engines having any number of cylinders. The nozzle outlets 41 of each fuel injector 17 are positioned for direct injection of fuel into individual cylinders 12 (only one of which is shown). In a conventional manner, a piston 14 reciprocates in each cylinder 12, with a compression ratio sufficient to compress air beyond an auto ignition condition of a compression ignition fuel, such as distillate diesel fuel, diesel biofuel and the like. Thus, engine 10, is a compression ignition engine, and includes no electronic spark initiating device such as a spark plug. Thus, ignition of a fuel charge injected from injector 17 relies upon compression ignition of a compression ignition fuel, which accounts for at least a fraction of the fuel leaving nozzle outlets 41. Fuel system 16 is designed such that a mixture of gasoline and a compression ignition fuel are supplied to the individual injectors 17 and injected into respective cylinders 12 as a blended mixture.

In the fuel system 16 illustrated in FIG. 1, the blended mixture of gasoline and the compression ignition fuel are pressurized to injection levels within the individual fuel injectors 17. Although fuel system 16 is illustrated as utilizing hydraulic actuation to pressurize the fuel blend in each of the individual fuel injectors 17, those skilled in the art will appreciate that cam actuated pressurization of the fuel mixture to be injected would also fall within the scope of the present disclosure. In addition, a common rail containing a mixture of gasoline and a compression ignition fuel that is pressurized to injection levels prior to being supplied to the individual injectors might also fall within the scope of the present disclosure, but might be less preferred due to potential lubrication issues and a possible lessened capability and quickly changing the ratio of gasoline to compression ignition fuel in the injected mixture.

Fuel system 16 includes a source of gasoline 20 that is fluidly connected to a first inlet 25 of a mixing ratio control valve 24 via a transfer pump 21. A source of compression ignition fuel 22 is fluidly connected to a second inlet 26 of mixing ratio control valve 24 via a separate transfer pump 23. An outlet 42 of the mixing ratio control valve 24 is fluidly connected to the fuel inlets 40 of each of the fuel injectors 17 via a mixed fuel supply passage 85. Although the fuel system 16 of FIG. 1 shows a common mixing ratio control valve 24 that is shared by all of the fuel injectors 17, different sharing combinations, and even a dedicated mixing ratio control valve for each fuel injector 17 would fall within the scope of the present disclosure.

Hydraulic fluid pressure from a common rail 34 supplied to a high pressure inlet 55 of each of the fuel injectors 17 provides the means by which the fuel mixture originating from mixing ratio control valve 24 is pressurized to injection levels in each of the individual fuel injectors 17. In the fuel system 16, pressurized compression ignition fuel is utilized as the hydraulic medium, but other available fluids, such as engine lubricating oil, could also be utilized without departing from the present disclosure. A rail supply pump 36 includes an inlet 37 fluidly connected to the source of compression ignition fuel 22 via transfer pump 23. Thus, a portion of the fuel pumped by transfer pump 23 finds its way to mixing ratio control valve 24, and another portion finds its way to common rail 34 via rail supply pump 36. In particular, an outlet 38 from rail supply pump 36 is fluidly connected to an inlet 33 of common rail 34. Common rail 34 may be equipped with a rail pressure limiting valve 88 that returns overpressurization fluid back to the source of compression ignition fuel 22 via a return line 89. After performing work to pressurize the fuel mixture within the fuel injector 17, the used, now low pressure, actuation fluid (compression ignition fuel from common rail 34) leaves each of the fuel injectors 17 at a low pressure drain 56 to be returned to the source of compression ignition fuel 22 via an actuation fluid return line for recirculation. For clarity, only one of the return lines 86 is shown.

Although it is conceivable that a mechanically controlled engine could fall within the scope of the present disclosure, engine 10 illustrated in FIG. 1 is electronically controlled via one or more electronic controllers 18. In the fuel system 16, each of the fuel injectors 17 includes at least one electrical actuator that receives control signals from electronic controller 18 via respective communication lines 90. Electronic controller 18 may receive information with regard to the pressure in rail 34 via a rail pressure sensor 94 that communicates via communication line 93. In turn, electronic controller 18 may control the pressure in common rail 34 via a rail pressure control actuator, which is incorporated into rail supply pump 36 and receives control signals via a communication line 91. Thus, rail supply pump 36 may be an electronically controlled throttle inlet type pump or may control output from the pump in another known manner, such as via electronically controlled spill valve(s) of the type known in the art. In still another alternative, pressure in the common rail may be controlled with an electronically controlled spill valve that returns a sufficient amount of fluid back to its source to maintain pressure in the common rail at some desired level. In addition to controlling the action of the individual fuel injector 17 and the pressure in common rail 34, electronic controller 18 may control the action of mixing ratio control valve 24 to control the ratio of gasoline to compression ignition fuel in outlet 42. Thus, mixing ratio control valve 24 may include an electrically controlled actuator 70 that receives mixing ratio control signals from electronic controller 18 via communication line 92.

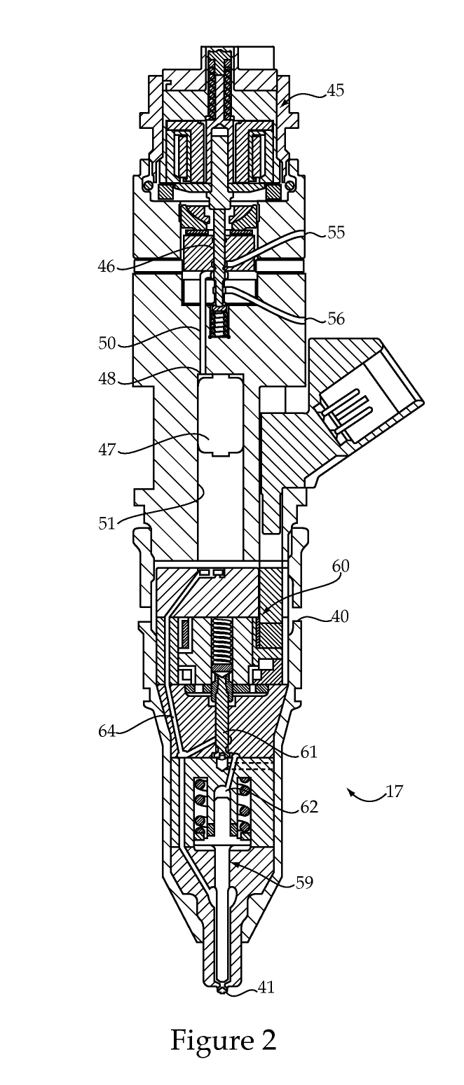

Referring now to FIG. 2, the inner structure of one of the fuel injectors 17 is illustrated. As stated earlier, the mixture of gasoline and compression ignition fuel enters fuel injector 17 at fuel inlet 40. The pressurized compression ignition fuel that acts as the actuation fluid enters at high pressure inlet 55 and leaves the fuel injector after performing work via low pressure drain 56. Fuel injector 17 includes an electronic pressure control actuator 45 (e.g., solenoid) that is operably coupled to move a valve member 46. In particular, valve member 46 may be biased to a position that fluidly connects an actuation fluid cavity 48 to low pressure drain 56 via an actuation fluid passage 50. When pressure control actuator 45 is energized, valve member 46 may move to a position that closes the fluid connection to low pressure drain 56 and opens high pressure inlet 55 to allow flow of pressurized fluid into actuation fluid cavity 48 via actuation and fluid passage 50. An intensifier piston 47 has one end exposed to fluid pressure in actuation fluid cavity 48 and an opposite end exposed to fluid pressure in a fuel pressurization chamber 51, which is fluidly connected to fuel inlet 40 via an internal passageway not shown. Intensifier piston 47 is shown in its fully retracted position with fuel pressurization chamber 51 loaded with a mixture of gasoline and compression ignition fuel for subsequent injection through nozzle outlets 41. In order to inhibit the leakage of gasoline past intensifier piston 47 into actuation fluid cavity 48, intensifier piston 47 may have an effective intensifier ratio less than or equal to one. After injection events when pressure control actuator 45 is deenergized, the transfer pressure in mixed fuel supply passage 85 is sufficient to push intensifier piston 47 back toward its retracted position as shown to expel used low pressure compression ignition fuel back toward its source 22 so that fuel injector 17 can be reset for a subsequent injection event.

The opening and closing of nozzle outlets 41 are enabled by fuel pressurization chamber 51 being pressurized to injection levels and by movement of a directly operated check 59. Directly operated checks are well known in the art and typically include a needle valve member that is biased into a position to close the nozzle outlets by a spring, but the needle valve member also includes a closing hydraulic surface exposed to fluid pressure in a control chamber. When pressure in the control chamber is high, the direct operated check is held closed and the nozzle outlets remain blocked. When pressure in the needle control chamber is low and fuel pressures are at injection levels, the direct operated check may move to an open position to allow the fuel to spray from nozzle outlets 41 in a known manner. In the illustrated embodiment, a needle control actuator 60, which may include a solenoid or piezo is operably coupled to move a needle control valve 61 between a first position in which a needle control chamber 62 is fluidly connected to low pressure fuel inlet 40 via a passage not shown, and a second position at which needle control chamber 62 fluidly connected to a nozzle supply passage 64. In the illustrated embodiment, the needle control chamber 62 is normally fluidly connected to nozzle supply passage 64 when needle control actuator 60 is deenergized, but the needle control chamber 62 becomes blocked to nozzle supply passage 64 and open to a low pressure passage connected to the fuel inlet 40 when energized. Thus, when both pressure control actuator 45 and needle control actuator 60 are energized, fuel may spray from nozzle outlets 41 into the respective engine cylinders 12 in a known manner. Although the needle control valve 61 is shown as a three way valve, other structures would fall within the scope of the present disclosure. In those alternatives, a so called A and Z orifice strategy are utilized and the needle control valve is a two way valve that opens and closes the low pressure fluid connection, whereas the needle control chamber is always fluidly connected to the nozzle supply passage via a small orifice. Such an alternative would also fall within the scope of the present disclosure. In still another alternative, a fuel injector with no direct control of the nozzle outlets would also fall within the intended scope of the present disclosure. In such a case, the needle check would simply be biased to close the nozzle outlets 41 by a spring with a certain pre-load to define a valve opening pressure. The check would include a opening hydraulic surface exposed to fluid pressure in the nozzle supply passage that would push the needle valve member upward to open the nozzle outlets 41 when fuel pressure exceeded the valve opening pressure defined by the biasing spring, and the needle check would close under the action of the spring when fuel pressure dropped below a valve closing pressure associated with the spring and the hydraulic surface areas of the needle check. Thus, those skilled in the art will appreciate that a wide variety of nozzle assemblies with different working structures would all fall within the intended scope of the present disclosure.

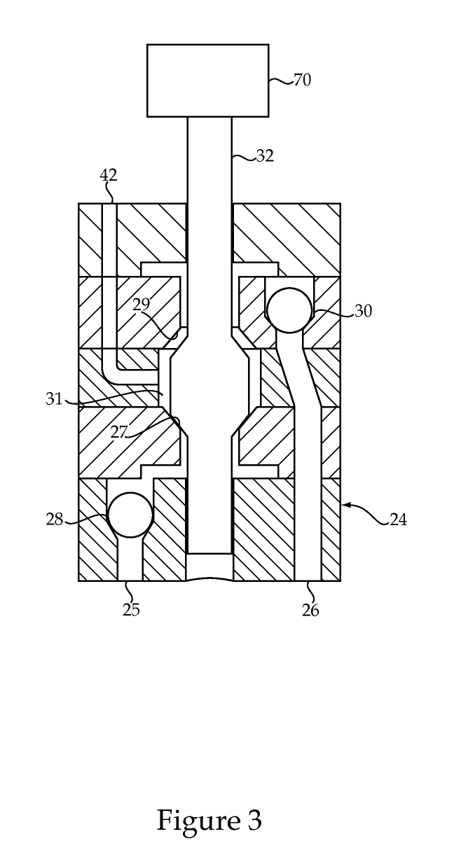

Referring now to FIG. 3, the inner structure of an example mixing ratio control valve 24 according to one embodiment of the present disclosure is illustrated. Mixing ratio control valve 24 includes a first inlet 25 which is shown fluidly connected to a source of gasoline in FIG. 1, and a second inlet 26 that is shown fluidly connected to the source of compression ignition fuel 22, also in FIG. 1. The outlet 42 may be connected to the mixed fuel supply passage 85. The mixing ratio actuator 70 may be a linear actuator, such as an electronically controlled stepper motor, or may include a hydraulic piston whose position is controlled via hydraulic fluid pressure via an electronically controlled valve. In either case, the mixing control actuator 70 can be considered a linear actuator that is operably coupled to move a valve member 32 between a first seat 27 and a second seat 29. Thus, in the illustrated embodiment, valve member 32 is a poppet valve that is trapped between seats 27 and 29. However, those skilled in the art will appreciate that a spool valve type structure could also be substituted in place of the poppet valve illustrated.

A first check valve 28 is fluidly positioned between first inlet 25 and first seat 27, and acts to prevent the back flow of mixed fuel back toward the source of gasoline 20. A second check valve 30 is fluidly positioned between second inlet 26 and second seat 29, and also prevents the back flow of mixed fuel toward the source of compression ignition fuel 22. The outlet 42 opens into the area 31 between first seat 27 and second seat 29. Thus, depending upon the position of valve member 32, the flow areas past respective seats 27 and 29 is changed, and hence the mixture ratio of fuel in area 31 and outlet 42 is changed. When the valve member 32 is in contact to close first seat 27, pure compression ignition fuel flows through mixing control valve 24. On the otherhand, if valve member 32 were in its upper most position closing seat 29, pure gasoline would flow into area 31 and out of outlet 42. Depending upon the pressures produced by transfer pumps 21 and 23 as well as the flow areas past seats 27 and 29, a continuum of different mixture ratios of gasoline to compression ignition fuel can be produced all the way from pure gasoline to pure compression ignition fuel and anywhere in between.

### INDUSTRIAL APPLICABILITY

The present disclosure is generally applicable to any compression ignition engine ranging from simple mechanical control through to the most sophisticated multi-wire electronically controlled engines known in the art. The present disclosure finds particular application in compression ignition engines where there is a desire to alter combustion characteristics by utilizing different mixture ratios of a compression ignition fuel with a less reactive fuel such as gasoline. The present disclosure finds potential application in having the ability to control mixture ratios of gasoline to compression ignition fuel in real time and independent engine operating conditions (i.e., speed and load). Engines according to the present disclosure may potentially reduce undesirable emissions produced as a result of the combustion process, and hence may be utilized to relax demands on exhaust aftertreatment systems.

Through testing and the like, engineers can develop maps for desired mixture ratios based upon any number of sensed or known variables including engine speed, engine load, desired emission profiles and other variables. These maps would be stored or accessible by electronic controller 18 and would be utilized to determine, generate and communicate mixing ratio control signals from electronic controller 18 to the linear actuator 70 of mixing ratio control valve 24. Depending upon engine operating conditions and desired combustion characteristics, electronic controller 18 can at any time change a control signal to mixing ratio control valve 24 and change the ratio of gasoline to compression ignition fuel in the supply line 85 The injection pressure may be controlled by electrical controller 18 via suitable control signals delivered to common rail supply pump 36, which may be driven directly by the engine. Finally, the timing at which fuel is pressurized within the fuel injector 17 may be controlled by energizing pressure control actuator 45 at a desired time. The control of the timing of fuel spray from fuel injector 17 is controlled by the timing at which the needle control actuator 60 is energized.

Those skilled in the art will appreciate that different front end and back end rate shaping and the like can be accomplished by varying the relative timing in the actuation and deactivation of the pressure control valve actuator 45 and the needle control actuator 60. For instance, if a ramp type front end shape were desired, the needle control actuator 60 could be energized before or contemporaneously with the pressure control actuator 45. On the otherhand, if a sort of square front end rate shape were desired, the needle control actuator would be energized well after the pressure control actuator has been energized to bring fuel up to injection pressure levels within the fuel injector 17.

When in operation engine 10 compresses air in each individual cylinder beyond an auto ignition condition of the compression ignition fuel. A first mixture of gasoline and compression ignition fuel of a first mixture ratio may be injected into the engine cylinder 12. Electronic controller may then command a change to a second mixture ratio by communicating a different mixture ratio control signal to the mixing ration control valve, which will respond by altering the respective flow areas past seats 27 and 29 (FIG. 3). Those skilled in the art will appreciate that although the mixture of gasoline and compression ignition fuel are supplied to the individual fuel injector 17 of engine 10 at a fuel transfer pressure, the mixed fuel is raised to an injection pressure in the respective fuel pressurization chambers 51 (FIG. 2) of each fuel injector 17. Fuel mixture pressurization is initiated by energizing the pressure control actuator 45 (FIG. 2) responsive to an actuation signal communicated from the electronic controller 18 to the individual fuel injector 17. This causes high pressure actuation fluid to flow into the individual fuel injector 17 to move the intensifier piston downward from the position shown in FIG. 2 to pressurize fuel in the fuel pressurization chamber 51. In the illustrated embodiment, the intensifier piston is moved hydraulically with pressurized compression ignition fuel from the common rail 34. Because the intensifier piston may have an intensification ratio less than or equal to 1, the pressure of the fuel in fuel pressurization chamber 51 will be less than or equal to the common rail pressure. Injection is initiated by energizing the needle control actuator 60 (FIG. 2) responsive to an injection signal communicated from the electronic controller 18 to the individual fuel injector 17. When this is done, the needle control chamber 62 becomes fluidly connected to the fuel inlet 40 of the fuel injector 17 responsive to the energization of the needle control actuator 60. An injection event is ended by de-energizing of either pressure control actuator 45 or needle control actuator 60. However, the end of injection may be made abrupt by de-energizing needle control actuator 60 prior to the de-energization of pressure control actuator 45.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A fuel system comprising:
a plurality of fuel injectors;
a source of gasoline;
a source of compression ignition fuel;
an electronically controlled mixing ratio control valve with a first inlet fluidly connected to the source of gasoline, and a second inlet fluidly connected to the source of compression ignition fuel, and an outlet fluidly connected to a fuel inlet of at least one of the fuel injectors, and the mixing ratio control valve being movable among a plurality of configurations corresponding to different ratios of gasoline to compression ignition fuel in the outlet;
an electronic controller in control communication with the mixing ratio control valve.

2. The fuel system of claim 1 including a common rail fluidly connected to each of the fuel injectors;
at least one rail pressure control actuator;
the electronic controller being in control communication with the at least one rail pressure control actuator.

3. The fuel system of claim 2 including a rail supply pump with an inlet fluidly connected to the source of compression ignition fuel and an outlet fluidly connected to an inlet of the common rail.

4. The fuel system of claim 1 wherein each of the fuel injectors includes a pressure control actuator; and
the electronic controller being in control communication with the pressure control actuator.

5. The fuel system of claim 4 wherein each of the fuel injectors includes an intensifier piston with one end exposed to fluid pressure in an actuation fluid cavity, and an opposite end exposed to fluid pressure in a fuel pressurization chamber;
the pressure control actuator being operably coupled to move a valve member between a first position at which the actuation fluid cavity is fluidly connected to a source of high pressure actuation fluid, and a second position at which the actuation fluid cavity is fluidly connected to a low pressure drain; and
the fuel pressurization chamber being fluidly connected to the fuel inlet.

6. The fuel system of claim 5 wherein the intensifier piston defines an intensification ratio less than or equal to one;
the source of high pressure actuation fluid is a common rail of pressurized compression ignition fuel; and
the low pressure drain is fluidly connected to the source of compression ignition fuel.

7. The fuel system of claim 1 wherein each of the fuel injectors includes a needle control actuator; and
the electronic controller being in control communication with the needle control actuator.

8. The fuel system of claim 7 including a needle control valve operably coupled to be moved by the needle control actuator between a first position at which a needle control chamber is fluidly connected to the fuel inlet, and a second position at which the needle control chamber is fluidly blocked from the fuel inlet.

9. The fuel system of claim 8 wherein the needle control chamber is fluidly connected to a fuel pressurization chamber when the needle control valve is at the second position, but fluidly blocked to the fuel pressurization chamber at the first position.

10. The fuel system of claim 1 wherein the mixing ratio control valve includes a valve member trapped to move between a first seat and a second seat, and includes a first check valve fluidly positioned between the first seat and the first inlet, and a second check valve fluidly positioned between the second seat and the second inlet, and the outlet being fluidly connected to an area between the first seat and the second seat.

11. The fuel system of claim 10 wherein the mixing ratio control valve includes a linear actuator operably coupled to move the valve member.

12. The fuel system of claim 11 wherein the linear actuator includes a stepper motor.

13. The fuel system of claim 11 wherein the linear actuator includes a hydraulic piston.

14. A method of operating an engine, comprising the steps of:
compressing air in an engine cylinder beyond an autoignition condition of a compression ignition fuel;
injecting a first mixture of gasoline and the compression ignition fuel of a first mixture ratio into the engine cylinder;
changing to a second mixture ratio responsive to a mixture ratio control signal communicated from an electronic controller to the mixing ratio control valve; and
injecting a second mixture of gasoline and the compression ignition fuel of the second mixture ratio into the engine cylinder.

15. The method of claim 14 including a step of supplying the mixture of gasoline and the compression ignition fuel at a fuel transfer pressure;
raising pressure of the mixture to an injection pressure in a fuel pressurization chamber of a fuel injector.

16. The method of claim 15 wherein the raising pressure step is initiated by energizing a first electrical actuator responsive to an actuation signal communicated from the electronic controller to the fuel injector.

17. The method of claim 16 wherein the raising pressure step includes moving an intensifier piston within the fuel injector.

18. The method of claim 17 wherein the intensifier piston is moved hydraulically with pressurized compression ignition fuel from a common rail;
the raising pressure step includes raising the pressure of the mixture to less than or equal to a common rail pressure.

19. The method of claim 18 including a step of initiating injection by energizing a second electrical actuator responsive to an injection signal communicated from the electronic controller to the fuel injector.

20. The method of claim 19 including a step of fluidly connecting a needle control chamber in the fuel injector to a fuel inlet of the fuel injector responsive to the step of energizing the second electrical actuator.
